(19) United States
(12) Patent Application Publication
(10) Pub. No.: US 2004/0012601 A1
(43) Pub. Date: Jan. 22, 2004

(54) Method and system for displaying a first image as a second image

(76) Inventors: Henry W. Sang JR., Cupertino, CA (US); Yihong Xu, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/197,568

(22) Filed: Jul. 18, 2002

(51) Int. Cl. G09G 5/00

(52) U.S. Cl. 345/581; 715/530; 345/634

(57) ABSTRACT

A method and system are disclosed for displaying a first image represented by a first set of data as a second image represented by a second set of data that is different than the first set of data, in which the first image is included in an electronic document. In accordance with exemplary embodiments of the present invention, the first set of data corresponding to the first image is received. The second set of data is produced by transforming the first set of data into at least one of a vector image representation and a textual description of the first image. The second image is substituted for the first image in the electronic document. An electronic link is established from the second image to the first image, such that the first image can be retrieved from a database using the second image.

### BACKGROUND

1. Field of the Invention

The present invention relates to image processing. More particularly, the present invention relates to a method and system for displaying a first image represented by a first set of data as a second image represented by a second set of data that is different than the first set of data.

2. Background Information

In compound electronic documents, images included with the text may be undesirable to store and communicate. For example, one method for handling electronic documents with images having large file sizes is to remove the image(s) from the electronic document. Removing the image(s), however, can degrade the appearance of the document as well as reduce the document's information value. Another method for handling electronic documents with images having large file sizes is to replace a high resolution image having a correspondingly large file size, with a lower (coarse) resolution copy of that image that has a smaller file size. This approach is used in the Open Pre-press Interface (OPI) that is found in conventional pre-press tools. The OPI uses a concept known as “For Placement Only” (FPO) images to hold a spot in a design that is substituted with the high- or original-resolution image at print time. Replacing the image with a coarse resolution copy, however, can affect the document's information value, as the lower (coarse) resolution copy can make it difficult to discern the nature and features of the original image(s).

Alternatively, the image(s) can remain intact in the document. Keeping the image(s) intact, however, can result in a document that has a larger overall file size that can make the file expensive, in terms of time, storage and bandwidth, to transfer to another user or another computer system, such as, for example, another user or computer system located on the Internet.

### SUMMARY OF THE INVENTION

A method and system are disclosed for displaying a first image represented by a first set of data as a second image represented by a second set of data that is different than the first set of data, in which the first image is included in an electronic document. In accordance with exemplary embodiments of the present invention, the first set of data corresponding to the first image is received. The second set of data is produced by transforming the first set of data into at least one of a vector image representation and a textual description of the first image. The second image is substituted for the first image in the electronic document. An electronic link is established from the second image to the first image, such that the first image can be retrieved from a database using the second image.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIGS. 1 and 2 are flowcharts illustrating the steps carried out for displaying a first image, in an electronic document, represented by a first set of data as a second image represented by a second set of data that is different than the first set of data in accordance with an exemplary embodiment of the present invention.

FIG. 3 is a flowchart illustrating the steps carried out for retrieving the electronic document with the first image in accordance with an exemplary embodiment of the present invention.

FIGS. 4A, 4B and 4C illustrate substituting a first image, in an electronic document, represented by a first set of data with a second image represented by a second set of data that is different than the first set of data in accordance with an exemplary embodiment of the present invention.

FIG. 5 illustrates segmenting an electronic document into a text document and images and creating alternate renditions of the various parts in accordance with an exemplary embodiment of the present invention.

FIG. 6 illustrates a system for displaying a first image, in an electronic document, represented by a first set of data as a second image represented by a second set of data that is different than the first set of data in accordance with an exemplary embodiment of the present invention.

### DETAILED DESCRIPTION OF THE PREFERRED EMBODIMENTS

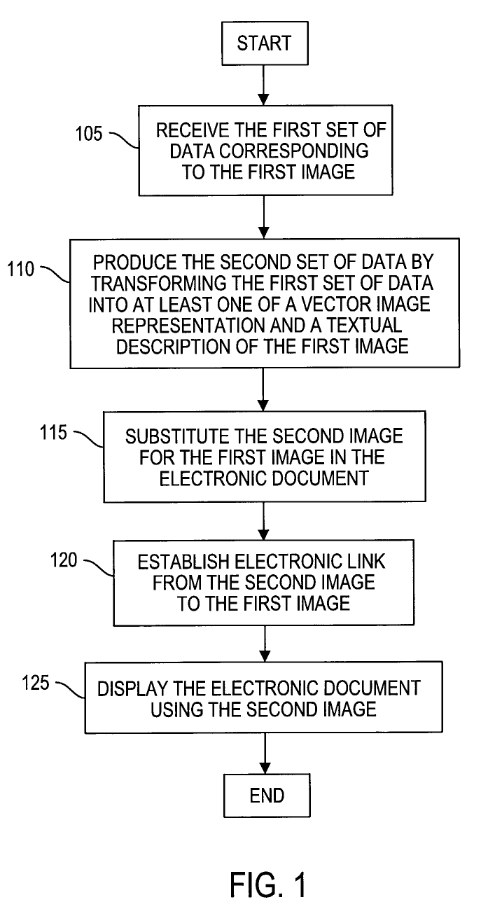

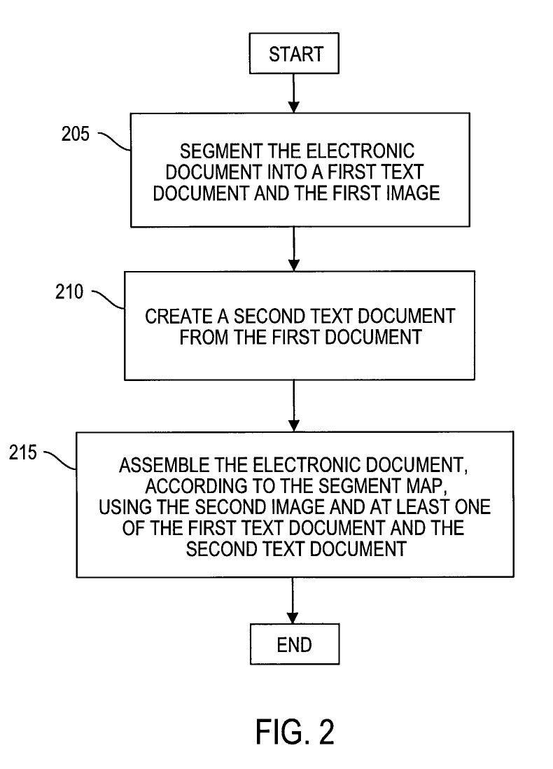

FIGS. 1 and 2 are flowcharts illustrating the steps carried out for displaying a first image represented by a first set of data as a second image represented by a second set of data that is different than the first set of data, in which the first image is included in an electronic document, in accordance with an exemplary embodiment of the present invention. The electronic document can be any electronic file, such as a compound electronic document that contains both text and images in electronic form.

In step 105 of FIG. 1, the first set of data corresponding to the first image is received. According to exemplary embodiments, an image is any digital image that is stored in electronic form in any type of electronic storage medium or computer memory. For example, a digital image can be any digital image, series of digital images, or digital video captured from any type of digital image or video capturing device, such as, for example, digital video cameras, digital cameras, video capture cards or any other image or video capturing device. Alternatively, a digital image can be an analog image, series of analog images, or analog video captured from, for example, cameras, video cameras or any other analog image or video capture device, that are scanned or otherwise digitized and stored as a digital image or digital video. According to exemplary embodiments, a set of data is any collection of information in electronic form that can comprise an electronic document or any part thereof, such as, for example, at least one digital image, the text of the electronic document, or even the electronic document itself.

According to exemplary embodiments, the first set of data corresponding to the first image can be received from any source or location. For example, the first set of data can be received from a remote location, such as, for example, a computer system located within a computer network, such as the Internet or any other type of computer network, using a network connection, such as, for example, an Ethernet connection or any other form of computer network connection. Alternatively, the first set of data can be received from a local location, such as from a computer database residing on a computer. Thus, the first set of data is received from any location using any form of electronic communication over which electronic information can be transmitted and received. The first set of data can also be derived from the electronic communication by, for example, decrypting the electronic information, enhancing the electronic information, etc.

In step 110, the second set of data is produced by transforming the first set of data into at least one of a vector image representation and a textual description of the first image. According to exemplary embodiments of the present invention, the images in a compound electronic document can be replaced with alternate representations of those images. The alternate representations can be, for example, a vector image representation of the first image, a textual description of the first image, a stylized or recognizable facsimile of the first image, an associated or known representation of the first image, any combination of these alternate representations, or any other form of alternate representation. The alternate representations of the original images have a different file size than the original images. For example, the alternate representations of the original images can have a smaller file size than the original images. Thus, according to exemplary embodiments, the second set of data can be smaller than the first set of data. The alternate representations are used to convey the same information as or better information than that contained in the original image, while, for example, reducing document size. The alternate representations can also assist in, for example, the indexing, the recognition, or the browsing of documents containing these types of images.

According to exemplary embodiments, the vector image representation of the first image can be, for example, any type of line drawing that is a visually meaningful and significant representation of the first image to a user. In addition, the vector image representation can have a reduced file size compared with the first image. The textual description of the first image can be, for example, a textual summary of the first image, identifying information that can be used with the vector image representation, or even the original text contained in the electronic document reformatted to take into account the vector image representation of the first image. Thus, the alternate representations of the first image can include, but are not limited to: a textual description of the original image; a machine-readable or other non-textual data representation, such as, for example, a bar code or other encoding including, but not limited to, watermarks, invisible inks, any machine readable encoding, and so forth; a caricature of the original image; a symbolic representation; or any other alternate rendition of the original image that can convey the information in the original image including, but not limited to a portion of the original image which has been cropped from the original image using, for example, a cropping rectangle (for example, a portion of the original specified by selected coordinates), or a reduced or enlarged scale version of the image or any portion of the image (for example, use of the upper left hand corner of an image magnified or reduced by a selected magnification or reduction). The alternate representations can, for example, reduce document size, and assist in, for example, the indexing, the recognition, or the browsing of documents containing these types of images.

In step 115, the second image is substituted for the first image in the electronic document. Once the first image is replaced, the first image can be stored in, for example, a computer database or any other type of electronic storage medium capable of storing electronic image information. The first image can be later retrieved from the computer database or electronic storage medium if it is desired to retrieve and reconstruct the original electronic document by replacing the second image with the first image.

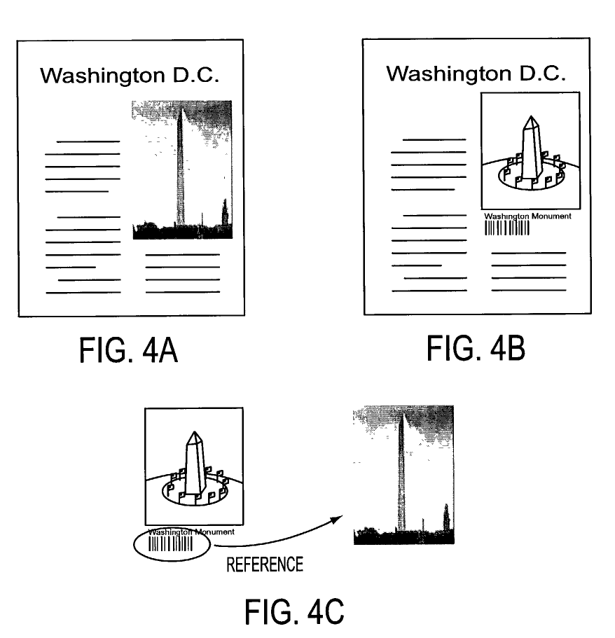

According to exemplary embodiments, the vector image representation of the first image can be a caricature of the first image that is visually meaningful to a user. A caricature of an original image conveys information that is equally or more visually meaningful to a user than the original image. In addition, a caricature of an original image can require much less memory space or storage than the original image itself. For example, a compound electronic document is shown in FIG. 4A. The document of FIG. 4A contains an image of the Washington Monument along with the text and layout of the document. As shown in FIG. 4B, the image of the Washington Monument is substituted with a caricature. The caricature of the Washington Monument in FIG. 4B is visually meaningful and significant to the user, since it conveys the image of the Washington Monument. However, in this instance, the caricature uses less memory or storage space than the original image of the Washington Monument in FIG. 4A.

Thus, a high- or medium-resolution caricature can be used instead of an original image in an electronic document. The caricature can be a known caricature that corresponds to the first image and that can be retrieved from a database of caricatures. The database of caricatures can be any computer database for storing electronic information, such as, for example, electronic image information. In such an exemplary embodiment, the contents of the first image can be, for example, automatically recognized and replaced with an associated caricature image from the database of caricatures that corresponds to the first image. The automatic recognition of the contents of first image can be performed with any form of image processing technique that uses, for example, shape, figure or scene recognition algorithms that use, for example, a person, face, or scene to provide data necessary to characterize the contents of an image.

Alternatively, the caricatures can be automatically generated from the first image. For example, “skeletonizing” techniques can be used to generate a caricature. Skeletonizing can be accomplished by, for example, retaining only the center pixel of each edge in the first image. The use of skeletonizing in the art of image processing is described, for example, in U.S. Pat. No. 6,058,219, the disclosure of which is hereby incorporated by reference. However, those of ordinary skill in the art will recognize that other image processing techniques can be used to generate a caricature from the original image. Other image processing techniques include, but are not limited to: thinning algorithms that thin the lines in an image; shape, figure or scene recognition algorithms that use, for example, a person, face, or scene to provide data necessary to generate a caricature (e.g., generating a composite image based on a sub-image content and replacement of the sub-image, such as, for example, generating an image of a “stick figure” caricature in an open field with mountains, sky, and sun in the background from an image of a person in the same background); generating a caricature based on relative sizing information; or any other image processing technique that can be used to automatically generate a caricature from an original image.

According to exemplary embodiments, the vector image representation of the first image can include identifying information associated with the first image. As is shown in FIG. 4B, the image of the Washington Monument is substituted with a caricature that also includes identifying information and a bar code. The identifying information can be a textual description of the image, such as, for example, the caption of the words “Washington Monument” as shown in FIG. 4B. However, the identifying information can be any graphical or textual information that identifies the image representation of the first image.

In step 120, an electronic link is established from the second image to the first image, such that the first image can be retrieved from a database using the electronic link. The electronic link is a reference to the storage location of the first image after the first image has been substituted with the second image. Accessing the electronic link takes the user to the storage location pointed to by the link or, conversely, retrieves the information pointed to by the electronic link. The electronic link can also be a description, such as, for example, classification information or any other form of description that can be used by, for example, a look-up service to retrieve the first image (or the entire original document or any part thereof) described by the electronic link from a database, library, or any other form of document repository.

As shown in FIG. 4C, the second image includes an electronic link or reference that can be, for example, a bar code that references or describes the first image. Alternatively, the second image itself can be the electronic link or reference to the first image (e.g., a watermark that incorporates a Uniform Resource Locator (URL), or a document-unique URL or other universal identifier).

However, the electronic link can be any type of reference, so long as it, for example, points to the storage location of the first image or otherwise describes the first image, and either provides or points to, for example, position identifiers that indicate where the first image is positioned in the electronic document. The position identifiers can include, for example, the name of the document, the page number of where the first image is located, the size of the first image, the coordinates of a point on the page where the first image is to be placed, and any other type of positioning information that indicates the location of the first image in the (original) electronic document. By accessing the electronic link or reference, the first image is retrieved from the database or other electronic storage medium where the first image is stored, along with any position identifiers that indicate the placement of the first image in the electronic document. For example, a user can click on the bar code of FIG. 4C using, for example, any computer pointing device, such as, for example, a computer mouse, to retrieve the first image.

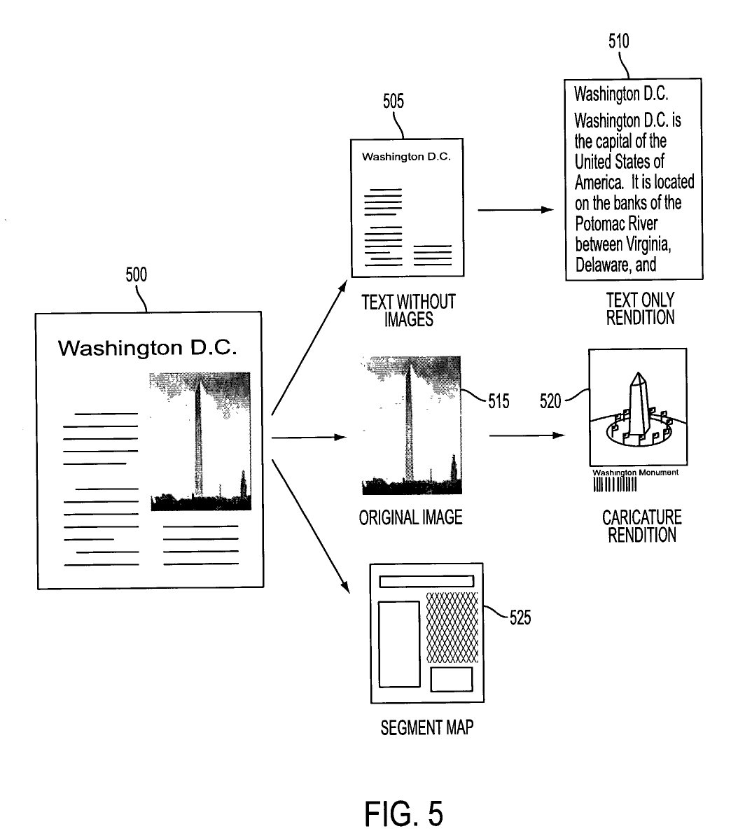

The steps illustrated in FIG. 1 for displaying a first image represented by a first set of data as a second image represented by a second set of data that is different than the first set of data in accordance with an exemplary embodiment of the present invention are explained in greater detail with reference to FIGS. 2 and 5. In step 205 of FIG. 2, the electronic document is segmented into a first text document and a first image, wherein the first text document and the first image are related using a segment map. As shown in FIG. 5, electronic document 500 can be a compound document that is comprised of both text and images. According to exemplary embodiments, electronic document 500 can be segmented or broken down into its constituent parts, for example, into its text and image components. For example, electronic document 500 can be segmented into a text document 505 (e.g., the first text document), which is the text of electronic document 500 without any images, and an original image 515 (e.g., the first image). Text document 505 and original image 515 are related using a segment map 525. Segment map 525 reveals the placement of text and images in electronic document 500, such as, for example, the placement of original image 515 relative to text document 505. If a document contains numerous images, each document page can be analyzed and segmented into multiple images, each of which is processed in turn and related using segment map 525. Segment map 525 is used to reassemble electronic document 500 from its constituent parts after electronic document 500 has been segmented.

In step 210 of FIG. 2, a second text document (e.g., text-only document 510) is created from the first text document, wherein the second text document is associated with the first text document. As shown in FIG. 5, a text-only document 510 can be created from text document 505. Thus, like text document 505, text-only document 5 10 can be a text-only rendition of electronic document 500 that does not contain any images. However, text-only document 510 can be, for example, reformatted to make use of the space formerly occupied by original image 515. According to exemplary embodiments, either text document 505 or text-only document 510 can be used to create the alternate rendition of electronic document 500. Caricature rendition 520 of original image 515 can, for example, be created or be retrieved from a database of caricatures in step 110 of FIG. 1. Caricature rendition 520 can be any vector image representation of original image 515 that is visually meaningful and significant to a user so that it conveys the same information as or better information than that contained in original image 515. In addition, caricature rendition 520 can occupy a smaller memory size or storage space than original image 515.

In step 215 of FIG. 2, the electronic document (e.g., electronic document 500) is assembled according to the segment map (e.g., segment map 525) using the second image (e.g., caricature rendition 520) and at least one of the first text document (e.g., text document 505) and the second text document (e.g., text-only document 510). Thus, electronic document 500 can be re-assembled using the caricature rendition of original image 515 and either the original text or a reformatted version of the original text of electronic document 500 to create an alternate rendition of electronic document 500. The alternate rendition of electronic document 500 can, for example, occupy less computer memory and storage space and have a smaller file size than the original version of electronic document 500. However, although different in file size, the alternate rendition of electronic document 500 conveys the same information as or better information than that contained in the original version of electronic document 500.

Once the alternate rendition of the original electronic document has been created using at least one of a vector image representation and a textual description of the first image, in step 125 of FIG. 1, the electronic document with the second image is displayed. This alternate rendition of the electronic document can be displayed using a computer monitor or any other video display device for displaying graphical and/or textual information to a user. The electronic document with the second image can also be stored in a computer database or in any other form of electronic storage medium for later retrieval.

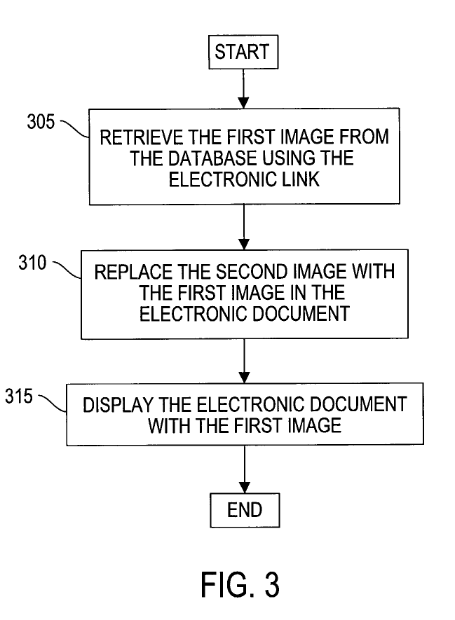

FIG. 3 is a flowchart illustrating the steps carried out for retrieving the electronic document with the first image in accordance with an exemplary embodiment of the present invention. Once the alternate rendition of the original electronic document has been created, the steps illustrated in FIG. 3 are carried out if a user wishes to retrieve the electronic document in its original form with the original image(s). In step 305, the first image is retrieved from the database using the electronic link or reference. As discussed previously, by accessing the electronic link or reference, the first image is retrieved from the database or other electronic storage medium where the first image is stored, along with any position identifiers that indicate the placements of the first image in the electronic document. For example, a user can click on the bar code of FIG. 4C using, for example, any computer pointing device, such as, for example, a computer mouse, to retrieve the first image.

In step 310, the second image is replaced with the first image in the electronic document. Thus, the original electronic document can be re-created by substituting the first image for the second image in the alternate rendition of the electronic document after the first image is retrieved from the database in which it has been stored. If the text of the original electronic document was also reformatted when the original image(s) were removed (e.g., to create text-only document 510 of FIG. 5), the alternate rendition of the electronic document can be re-formatted back into its original form before the first images are replaced. Once the original electronic document has been re-created, in step 315 the electronic document with the first image is displayed. The original electronic document can be displayed using a computer monitor or any other video display device for displaying graphical and/or textual information to a user.

Thus, the alternate rendition of the original electronic document can be stored as a complete document with electronic links from the secondary image(s) to the parent (i.e., original) document. To retrieve the original document, the electronic links from the secondary images to the parent document, along with position identifiers, can be used to automatically re-create the entire original document for a user.

Consequently, exemplary embodiments of the present invention can automatically generate an alternate rendition of an electronic document that incorporates alternate representations of images contained in the electronic document. The alternate representations of images are visually meaningful and significant images that convey the same information as or better information than that contained in the original images of the original electronic document. In addition, the alternate representations can reduce the resulting file size of the electronic document. The original electronic document can also be automatically re-created from the alternate rendition of the electronic document by automatically replacing the alternate representations of the images and text with their respective original versions.

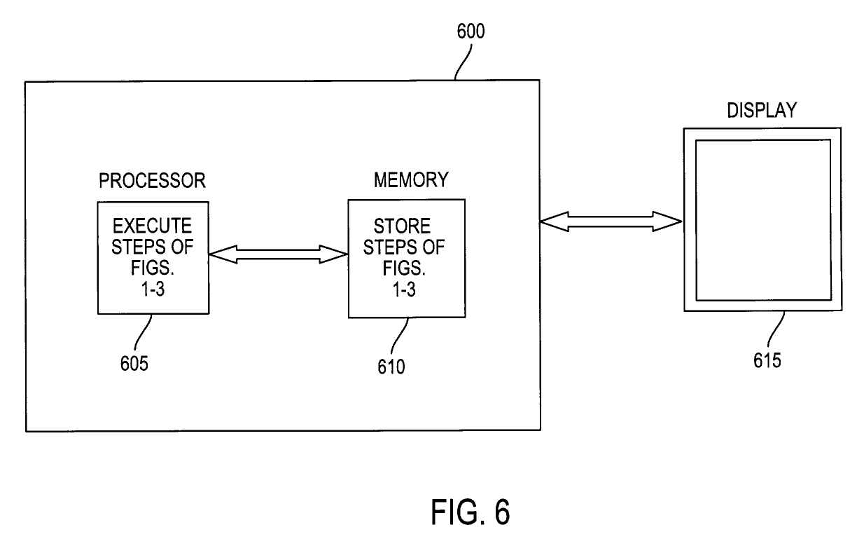

A system for displaying a first image represented by a first set of data as a second image represented by a second set of data that is different than the first set of data, wherein the first image is included in an electronic document, in accordance with an exemplary embodiment of the present invention will be described with reference to FIG. 6. The electronic document can be any compound electronic document that contains both text and images in electronic form.

According to exemplary embodiments, the steps of a computer program as illustrated in FIGS. 1-3 can be performed using a computer 600, such as, for example, a personal computer or any other computer system. Computer 600 can include a memory 610. Memory 610 can be any computer memory or any other form of electronic storage media that is located either internally or externally to computer 600. Memory 610 can store, for example, the steps of a computer program as illustrated in FIGS. 1-3. As will be appreciated based on the foregoing description, memory 610 can be programmed using conventional, techniques known to those having ordinary skill in the art of computer programming to carry out the steps of a computer program as illustrated in FIGS. 1-3 described herein. The actual source code or object code for carrying out the steps of a computer program as illustrated in FIGS. 1-3 can be stored in memory 610.

Memory 610 stores steps of a computer program to receive the first set of data corresponding to the first image, to produce the second set of data by transforming the first set of data into at least one of a vector image representation and a textual description of the first image, to substitute the second image for the first image in the electronic document, and to establish an electronic link from the second image to the first image, such that the first image can be retrieved from a database using the electronic link. The first set of data is received from any location using any form of electronic communication over which electronic information can be transmitted and received.

According to exemplary embodiments, the electronic link or reference can include a bar code that is associated with the first image. However, the electronic link can be any type of reference, so long as it points to, for example, the storage location of the first image (or the original document), and either provides or points to, for example, position identifiers that indicate where the first image is positioned in the electronic document. The first image (and any associated position identifiers) can be stored in, for example, a computer database or any other type of electronic storage medium capable of storing electronic image information from which the first image can be later retrieved using the electronic link. The computer database or other type of electronic storage medium that stores the first image can reside either locally to computer 600 (e.g., in memory 610) or externally to computer 600 (e.g., in a computer located in another computer network) and connected to computer 600 via any type of computer network connection, such as, for example, an Ethernet connection, or any other form of electronic connection that allows for the communication of electronic information.

According to exemplary embodiments, the vector image representation of the first image can be, for example, any type of line drawing that is a visually meaningful and significant representation of the first image to a user. The vector image representation of the first image can have a reduced file size compared with the first image. For example, the vector image representation of the first image can be a caricature of the first image that is visually meaningful to a user. The caricature can be a known caricature that corresponds to the first image and that can be retrieved from a database of caricatures. The database of caricatures can be any computer database for storing electronic information, such as, for example, electronic image information. The computer database can reside either locally to computer 600 (e.g., in memory 610) or externally to computer 600 (e.g., in a computer located in another computer network) and connected to computer 600 via any type of computer network connection, such as, for example, an Ethernet connection, or any other form of electronic connection that allows for the communication of electronic information.

According to an alternate exemplary embodiment, the caricatures can be generated automatically from the first image. However, any form of alternate rendition of the original image can be used, so long as the alternate rendition conveys the same or better information as that contained in the original image. The caricature can also reduce the document size. Thus, the second set of data can be smaller than the first set of data. According to exemplary embodiments, the vector image representation of the first image can include identifying information associated with the first image.

Memory 610 stores steps of a computer program to segment the electronic document into a first text document and the first image, wherein the first text document and the first image are related using a segment map, to create a second text document from the first text document, wherein the second text document is associated with the first text document, and to assemble the electronic document, according to the segment map, using the second image and at least one of the first text document and the second text document. Memory 610 also stores steps of a computer program to display the electronic document with the second image.

Memory 610 also stores steps of a computer program to retrieve the first image from the database using the electronic link, to replace the second image with the first image in the electronic document, and to display the electronic document with the first image. The original and alternate renditions of the electronic document can be displayed to a user on a display, such as, for example, display 615, that is used in conjunction with computer 600. Display 615 can be a computer monitor or any other video display device for displaying graphical and/or textual information to a user.

Computer 600 also includes a processor 605 for accessing memory 610 to execute the steps of a computer program as illustrated in FIGS. 1-3. Processor 605 can be any known processor, such as, for example, a microprocessor. Computer 600 can also be connected to at least one other computer in a computer network using any form of network connection, such as, for example, an Ethernet connection.

The steps of a computer program as illustrated in FIGS. 1-3 for displaying a first image represented by a first set of data as a second image represented by a second set of data that is different than the first set of data, wherein the first image is included in an electronic document, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for displaying a first image represented by a first set of data as a second image represented by a second set of data that is different than the first set of data, wherein the first image is included in an electronic document, the method comprising the steps of:
receiving the first set of data corresponding to the first image;
producing the second set of data by transforming the first set of data into at least one of a vector image representation and a textual description of the first image;
substituting the second image for the first image in the electronic document; and
establishing an electronic link from the second image to the first image, wherein the first image can be retrieved from a database using the electronic link.

2. The method of claim 1, wherein the second set of data is smaller than the first set of data.

3. The method of claim 1, wherein the vector image representation of the first image is a caricature of the first image.

4. The method of claim 1, wherein the vector image representation of the first image includes identifying information associated with the first image.

5. The method of claim 1, wherein the electronic link includes a bar code that is associated with the first image.

6. The method of claim 1, comprising the step of:
segmenting the electronic document into a first text document and the first image, wherein the first text document and the first image are related using a segment map;
creating a second text document from the first text document, wherein the second text document is associated with the first text document; and
assembling the electronic document, according to the segment map, using the second image and at least one of the first text document and the second text document.

7. The method of claim 1, comprising the step of:
displaying the electronic document with the second image.

8. The method of claim 1, comprising the steps of:
retrieving the first image from the database using the electronic link;
replacing the second image with the first image in the electronic document; and
displaying the electronic document with the first image.

9. A system for displaying a first image represented by a first set of data as a second image represented by a second set of data that is different than the first set of data, wherein the first image is included in an electronic document, comprising:
a memory that stores the steps of a computer program to:
receive the first set of data corresponding to the first image,
produce the second set of data by transforming the first set of data into at least one of a vector image representation and a textual description of the first image,
substitute the second image for the first image in the electronic document, and
establish an electronic link from the second image to the first image, such that the first image can be retrieved from a database using the electronic link; and
a processor for accessing the memory to execute the computer program.

10. The system of claim 9, wherein the second set of data is smaller than the first set of data.

11. The system of claim 9, wherein the vector image representation of the first image is a caricature of the first image.

12. The system of claim 9, wherein the vector image representation of the first image includes identifying information associated with the first image.

13. The system of claim 9, wherein the electronic link includes a bar code that is associated with the first image.

14. The system of claim 9, wherein the memory stores steps of a computer program to:
segment the electronic document into a first text document and the first image, wherein the first text document and the first image are related using a segment map;
create a second text document from the first text document, wherein the second text document is associated with the first text document; and
assemble the electronic document, according to the segment map, using the second image and at least one of the first text document and the second text document.

15. The system of claim 9, wherein the memory stores steps of a computer program to:
display the electronic document with the second image.

16. The system of claim 9, wherein the memory stores steps of a computer program to:
retrieve the first image from the database using the electronic link;
replace the second image with the first image in the electronic document; and
display the electronic document with the first image.

17. A computer-readable medium containing a computer program for displaying a first image represented by a first set of data as a second image represented by a second set of data that is different than the first set of data, wherein the first image is included in an electronic document, by performing the steps of:
receiving a first set of data corresponding to a first image, wherein the first image is represented by the first set of data, and wherein the first image is included in an electronic document;
producing a second set of data corresponding to a second image by transforming the first set of data into at least one of a vector image representation and a textual description of the first image, wherein the second image is represented by the second set of data, and wherein the second set of data is different than the first set of data;
substituting the second image for the first image in the electronic document; and
establishing an electronic link from the second image to the first image, such that the first image can be retrieved from a database using the electronic link.

18. The computer-readable medium of claim 17, wherein the vector image representation of the first image is a caricature of the first image.

19. The computer-readable medium of claim 17, wherein the computer program performs the steps of:
segmenting the electronic document into a first text document and the first image, wherein the first text document and the first image are related using a segment map;
creating a second text document from the first text document, wherein the second text document is associated with the first text document; and
assembling the electronic document, according to the segment map, using the second image and at least one of the first text document and the second text document.

20. The computer-readable medium of claim 17, wherein the computer program performs the steps of:
retrieve the first image from the database using the electronic link;
replace the second image with the first image in the electronic document; and
display the electronic document with the first image.
